(19) United States
(12) Patent Application Publication
(10) Pub. No.: US 2006/0288184 A1
(43) Pub. Date: Dec. 21, 2006

(54) Admission control in data storage devices

(75) Inventors: Alma Riska, Pittsburgh, PA (US); Erik Riedel, Pittsburgh, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/155,410

(22) Filed: Jun. 17, 2005

(51) Int. Cl. G06F 13/00; G06F 12/00

(52) U.S. Cl. 711/167; 711/112

(57) ABSTRACT

A method for processing requests in a data storage system, the method comprising: receiving a plurality of requests, each of the requests including a block address; and determining if successive ones of the requests are sequential stream requests by using arrival times of the successive requests and the block addresses of the successive requests. The method can also determine if disc workload is sequential or random, and requests can be selected to be postponed based on the workload characteristics in the case of overload when admission control is needed to achieve gradual degradation in performance. Apparatus that performs the method is also provided.

### FIELD OF THE INVENTION

This invention relates to data storage systems, and more particularly to the scheduling of tasks in data storage systems.

### BACKGROUND OF THE INVENTION

Block data storage devices store and/or retrieve digital data in the form of blocks, which are individually addressable by a host device. Exemplary block data storage devices include hard disc drives, optical disc recorders and players, and magnetic digital tape recorders and players.

Such devices typically comprise a hardware/firmware based interface circuit having a buffer (first memory location), a communication channel and a recordable medium (second memory location). The user memory space of the second memory location is divided into a number of addressable blocks, which are assigned host-level addresses (sometimes referred to as logical block addresses or LBAs).

To write data to the medium, the host device issues a write command comprising the user data to be stored by the storage device, along with a list of LBAs to which the user data are to be stored. The storage device temporarily stores the user data in the first memory location, schedules movement of a data transducing head to the appropriate location(s) over the medium, and then uses write channel portions of the communication channel to apply the appropriate encoding and conditioning of the data to write the data to the selected LBAs.

To subsequently read the data from the storage device, the host device issues a read command identifying the LBAs from which data are to be retrieved. The storage device schedules movement of the data transducing head to the appropriate location(s) over the medium, and then uses read channel portions of the communication channel to decode readback data which are placed into the first memory location (buffer) for subsequent transfer back to the host device.

A typical data storage device is configured to concurrently handle multiple pending access (read and write) commands from the host device. The commands are arranged into a command queue and a sort strategy is used to identify a sequence of execution of the pending access commands in hopes of optimizing the rate at which data are transferred between the host device and the data storage device.

A typical sort strategy involves calculating the elapsed time that would be required to move the data transducing head to the appropriate physical address of the medium in order to service each command. Generally, the access command that can be serviced in the shortest access time is selected from the command queue as the next command to be executed.

Computer systems, in general, and the storage subsystem in particular, experience bursty request arrivals. This can cause system overload and drastic performance degradation. Handling overload is critical for high service availability of the system and/or device because, in extreme cases, overload causes a system to crash. In the upper layers of a computer system, admission control algorithms reject new requests if a certain threshold is reached on the number of outstanding requests.

The goal of admission control algorithms is to maintain good overall performance for those requests already accepted by the system. For example, servers that provide services over a network will use admission control algorithms to reject requests for a new network connection if the bandwidth requirements for the new connection would cause the total requested bandwidth to exceed the available bandwidth and consequently negatively affect performance. At the disc level, requests that arrive cannot be rejected or dropped. Hence, an admission control algorithm at the disc will not behave as a traditional admission control algorithm.

The characteristics of the disc drive workload are critical to performance. Disc scheduling algorithms, buffer management, and prefetching algorithms perform differently under different workloads.

There is a need for an admission control technique at the disc level, which can adapt better disc operation to the current workload for better performance, and can provide for graceful degradation of performance in case of an overload.

### SUMMARY OF THE INVENTION

This invention provides a method for processing requests in a data storage system. The method comprises: receiving a plurality of requests, wherein each of the requests includes a block address, and determining if successive ones of the requests are part of a stream of sequential requests by using arrival times of the successive requests and the block address of the successive requests. The method can also determine if disc workload is sequential or random.

In another aspect, the invention provides a method for providing admission control while processing requests at the disc drive, wherein the method comprises: receiving a plurality of requests, assigning the requests to a queue, and if the number of requests in the queue exceeds a threshold number, then service is postponed for selected ones of the requests, wherein the selection of postponed requests is based on whether a workload is random or sequential. Then the postponed requests represent a portion of the workload penalized by the admission control algorithm at the disc drive.

The invention also encompasses an apparatus comprising a controller for receiving a plurality of requests, each of the requests including a block address, wherein the controller includes a processor for determining if the successive requests are stream requests by using arrival times of successive ones of the requests and the block addresses of the successive requests.

In another aspect, the invention provides an apparatus comprising a controller for receiving a plurality of requests and for assigning the requests to a queue, wherein if the number of requests in the queue exceeds a threshold number, then service is postponed for selected ones of the requests, wherein the selection of postponed requests is based on whether a workload is random or sequential.

### BRIEF DESCRIPTION OF THE DRAWINGS

FIG. 1 is a pictorial representation of the mechanical portion of a disc drive that can be constructed in accordance with the invention.

FIG. 2 is a block diagram of a disc drive that can include the components of FIG. 1.

FIG. 3 is a flow diagram that illustrates the method of this invention.

FIG. 4 is a flow diagram that illustrates the request scheduling of this invention.

FIGS. 5 and 6 are graphs that illustrate the performance of the invention.

### DETAILED DESCRIPTION OF THE INVENTION

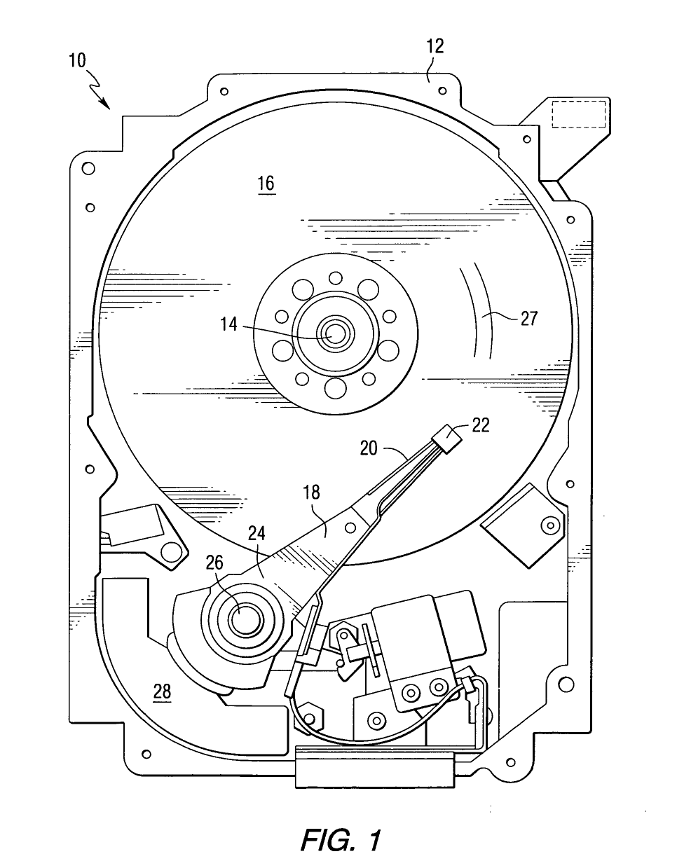

Referring to the drawings, FIG. 1 is a pictorial representation of the mechanical portion of a disc drive 10 that can be constructed in accordance with the invention. The disc drive includes a housing 12 (with the upper portion removed and the lower portion visible in this view) sized and configured to contain the various components of the disc drive. The disc drive includes a spindle motor 14 for rotating at least one data storage medium 16 within the housing, in this case a magnetic disc. At least one arm 18 is contained within the housing 12, with each arm 18 having a first end 20 with a recording and/or reading head or slider 22, and a second end 24 pivotally mounted on a shaft by a bearing 26. An actuator motor, which may be a voice coil motor 28, is located at the arm's second end 24, for pivoting the arm 18 to position the head 22 over a desired sector of the disc 16. Data is stored in a plurality of concentric tracks 27 on the storage medium. Command and control electronics for the disc drive are provided on a printed circuit board (PCB) mounted in the housing.

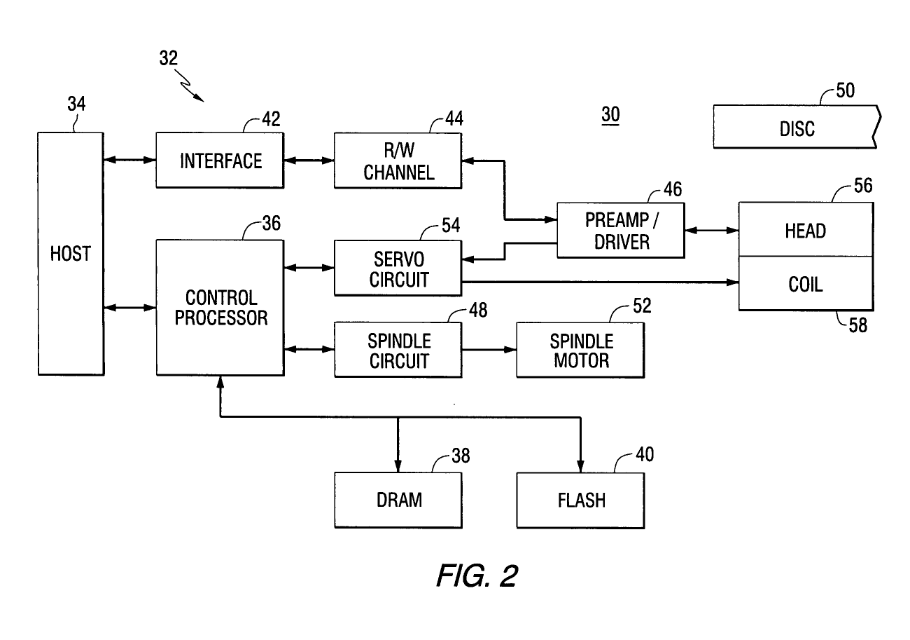

A functional block diagram of a system including a disc drive 30, having control circuitry 32, is provided in FIG. 2. A host computer 34 provides a stream of requests to the disc drive. A disc drive control processor 36 controls the operation of the disc drive 30 in accordance with programming and information stored in dynamic random access memory (DRAM) 38 and non-volatile flash memory 40.

Data to be stored by the disc drive are transferred from the host computer 34 to an interface circuit 42, which includes a data buffer for temporarily buffering the data and a sequencer for directing the operation of a read/write channel 44 and a preamp/driver circuit 46 during data transfer operations. A spindle circuit 48 is provided to control the rotation of the discs 50 by the spindle motor 52.

A servo circuit 54 is provided to control the position of one or more recording heads 56 relative to the discs 50 as part of a servo loop established by the head 56, the preamp/driver 46, the servo circuit 54 and the coil 58 that controls the position of an actuator arm. The servo circuit 54 includes a digital signal processor (DSP) which is programmed to carry out two main types of servo operation: seeking and track following.

The host device can issue requests for writing and/or reading data. The outstanding requests in the storage subsystem in general, and at the disc drives in particular, cannot be rejected. The requests should be served at some point in time. However, the disc can “ignore” some requests for a limited time, until the overload condition has passed, for graceful degradation in performance. This invention addresses overload at the disc level by introducing disc-level deadlines.

This invention determines how to assign a disc-level deadline to each incoming request. In a normal operation, the invention does not alter the disc operation, which means that the deadlines of all incoming requests are current. In an overload situation, the invention determines, based on the characteristics of the incoming workload, which requests should have deadlines further in the future and which requests should have current deadlines. A request with a non-current (and far-in-the future deadline) is referred to as “postponed” request. Every time another request has to be scheduled for service, a disc scheduling algorithm (usually Shortest Position Time First—SPTF) selects among the requests with immediate deadlines.

The method is guided by the user-level perceived performance. Each user-level (or application) request corresponds to a sequence of disc requests usually placed together on the disc media (i.e., a sequential stream). Long user-level requests correspond to long sequential streams, i.e., hundreds of Kbytes in size and hundreds of disc requests, while short user-level requests correspond to short sequential streams, i.e., few Kbytes in size and only a few disc requests. Hence, if the workload includes a mix of sequential streams, then the longest ones are postponed so as to penalize only a few long user-level requests. If the workload includes a mix of very short streams (i.e., it is random) then the requests to be postponed are selected in a random fashion. The reasoning behind postponing long sequential request streams is that at the application level, long user-requests are expected to take longer to service than the short ones. By delaying them even more, the request slowdown which is measured as the ratio of the response time of a user-level requests to its expected service time, is less than for short user-level requests.

The stream-detect algorithm is used to identify specific characteristics of the disk drive workload. Using the algorithm, the disc controller can determine if the received requests are fully random, localized to a specific area of the disc, and/or contain sequential streams. The algorithm maintains a list of sequential streams of requests. Each sequential stream starts with a single request and grows in length as new requests arrive that are part of that stream. By maintaining a list of sequential streams rather than statistics on individual requests, this invention provides a compact representation and coarse-scale understanding of workload characteristics.

The stream-detect algorithm monitors requests that arrive at the disc and constructs a list of sequential streams by following rules described below. The length of this list is related to how far back the statistics for the disc drive workload are maintained. The list of sequential streams can be stored in the dynamic random access memory (DRAM) of the disc drive and, because its space is limited, the length of the list of sequential stream is determined by the available memory size for workload characterization purposes. In an environment with large DRAM, the length of the list can be increased and if the available DRAM is small, then the length of the list can be decreased. A larger list length increases the accuracy of the workload characterization part of the algorithm.

There are two ways of keeping track of the disc workload history, based on a sliding window having a constant time interval, or based on the number of requests received. The following description focuses on the former, using a time interval of length TIME_GAP. However, the same rationale applies if the history length is determined by the number of requests.

Each request includes a block address and has an arrival time. For each incoming request, the algorithm determines if that request is part of an existing stream or initiates a new stream. A random request is considered a stream of length l. There are several parameters that can be used to determine if a new request is part of a stream.

STREAM_GAP is a parameter that indicates the largest possible distance in number of blocks between two consecutive requests of the same stream.

TIME_GAP is a parameter that indicates the maximum interval (in ms) between arrival times of two consecutive requests in a stream. If for a given stream the latest arrival happened at least TIME_GAP milliseconds before the current time, then the stream is considered “old” and deleted from the workload history, that is, it is deleted from the list of streams. Only the old streams are deleted. This means that all streams having requests that have arrived before TIME_GAP milliseconds (i.e. those that have had activity sometime in the last TIME_GAP milliseconds) are not deleted even if the incoming request is not part of them. This is why the history records only for TIME_GAP milliseconds. Everything that is older and deleted is no longer stored, and does not affect any future decisions.

FRACTION is a parameter that indicates what portion of the requests must be part of a stream for a workload to be considered sequential.

In one embodiment of the invention, for each stream, the following information is stored.

1. stream.max-gap: maximum recorded gap distance (in blocks) for the stream.

2. stream.min-gap: minimum recorded gap distance (in blocks) for the stream.

3. stream.average-gap: average recorded gap distance (in blocks) for the stream.

4. stream.access-time: the arrival time of the latest request in the stream.

5. stream.no-of-reqs: number of requests that are part of the stream.

6. stream.no-of-blocks: number of blocks requested by the stream.

7. stream.first-block: the first block of the first request in the stream.

8. stream.last-block: the last block of the last request in the stream.

In addition to the above information, global counters can be used to keep track of the following information for the current disc workload, i.e., in the last TIME_GAP milliseconds.

1. No_Reqs.: the number of requests in the current history.

2. No_Streams: the number of streams currently recorded in the history.

3. Smallest_Block: the smallest block currently recorded in the history.

4. Largest_Block: the largest block currently recorded in the history.

While statistics are updated upon each request arrival, an analysis to determine the workload characteristics can be performed at regular intervals of time (or after a predetermined number of requests has been received) since it is not expected that single requests will change the workload enough to trigger a change in disc operation.

The stream-detect algorithm assists a disc drive in knowing the current characteristics of the disc drive workload. The accuracy of prediction is related to the amount of history that is monitored and the diversity of the collected statistics.

The pseudo-code of the stream-detect algorithm is:

```
1. Request req arrives
        Increase No_Reqs by 1
2. For any stream in the streams list
      3. if (req.arrival_time − stream.access_time < TIME_GAP) AND
      (req.start_block − stream.last_block < STREAM_GAP)
              add request to the existing stream
              update stream statistics
              update global statistics
      4. if (current_time − stream.access_time > TIME_GAP)
              decrease No_Reqs by stream.no-of-reqs decrease
              No_Streams
                by 1
              delete stream
      5. if (req. not in any stream in the streams list)
              create a new stream
              increase No_Streams by 1
              update global statistics
      6. if (No_Reqs × FRACTION > No_Streams)
              Workload has sequential streams
      Else
              Workload is random
      7. if (Largest-Block − Smallest-Block < FRACTION × Available-
                Space)
              Workload is local
      Return to Step 1.
```

Extensions to this algorithm are possible on both the global statistics and per stream statistics. Global counters can keep information on various time scales. In today's computer systems, a good amount of periodicity is observed in the intensity of arrivals or data requested. In particular, the periodicity can be related to time of day or time of week. This periodicity can be traced, and operations such as prefetching or scrubbing can be scheduled according to it. Additional global statistics can also help to quantify the amount of locality or randomness that is observed in a workload. Randomness is defined in step 6 and locality is defined in step 7, that is, only for TIME_GAP ms. If needed, additional statistics can track larger intervals of time while still maintaining detailed stream-level statistics for the TIME_GAP ms period.

In this invention, the stream-detect algorithm is used in the disc-level admission control algorithm. At the upper layers of a computer system, an admission control algorithm rejects new incoming requests to ensure stable performance for the already accepted requests. At the disc level, the requests cannot be dropped (as in upper layers of a computer system) when the load levels are higher than expected. To emulate the higher-level admission control algorithm, the execution of some requests is postponed at the disc level. In order to affect as few user-level processes as possible, where streams are present, entire streams are postponed to allow the rest of the requests to be served faster. While the stream-detect algorithm provides a basis for simple scheduling and admission control algorithms, it can also be used for caching and prefetching algorithms.

In another aspect, this invention provides a stream-based admission control algorithm that provides a heuristic for handling short-lived overloads at the disc. Under normal operating conditions, the admission control algorithm reduces to the Shortest Positioning Time First (SPTF) algorithm. This invention improves the worst-case SPTF technique without affecting the average case. The stream-based admission control algorithm bases its decisions on information provided by the stream-detect algorithm, which provides information on the characteristics of the current workload at the discs, such as randomness and sequentially. There are several parameters, as described below, used in the stream-based admission control algorithm.

LONG_QUEUE is a threshold number of outstanding requests that activates the admission control algorithm.

LONG_STREAM is a threshold number that determines if a stream is long, that is, if many requests have been part of the stream and are worth postponing since the entire stream will take a long time to service.

POSTPONE is a period of time for which some requests are postponed.

INTERVAL is a period of time that determines requests with immediate deadlines. These requests are used by a SPTF scheduling algorithm to select the next request for service.

The pseudo-code of the admission control algorithm is:

```
1. A new request arrives
        Run the stream-detect Algorithm
        go to Step 3
2. A request completes its service
        Schedule requests with deadline in the current INTERVAL
        ms using
        SPTF
        go to Step 7
3. if (the number of outstanding requests> LONG_QUEUE)
        activate admission control
        go to Step 4
      else
        request. deadline = current time
        go to Step 6
4. if (workload is random)
        drop_probability = LONG_QUEUE / queue length
        random = Select_a_random_number
        if (random > drop_probability)
              request. deadline = current time + POSTPONE ms
5. if (workload is sequential)
        if (request is part of a stream longer than LONG_STREAM)
        blocks
        request.deadline = current time + POSTPONE ms
6. Insert request in the queue ordered by request.deadline
        go to Step 7
7. Evaluate the next event
        if (new arrival)
              go to Step 1
        if (completion)
              go to Step 2.
```

Step 4 is similar to step 5 but in step 4 the workload is random and it is not effective to drop streams since they are all short. The DROP_PROBABILITY indicates how much the queue length exceeds the threshold LONG_QUEUE. Hence, by selecting a random number between 0 and 1 uniformly, then only the excessive part of the queue is dropped, which is indicated by the portion of the random number larger than DROP_PROBABILITY. In this way, the algorithm does not postpone every single request in the queue, but only as many as are needed to assure normal service for the non-postponed requests. Therefore, the queue of non-postponed requests is at most LONG_QUEUE.

By keeping track of current changes in the characteristics of the workload, the admission control algorithm operates as an adaptive algorithm. In addition, by extending the set of statistics collected by the stream-detect algorithm, the admission control algorithm can further increase its adaptation to the current workload characteristics. A simple extension is to dynamically adjust the values of parameters like LONG_STREAM and POSTPONE. The values of parameters like INTERVAL and LONG_QUEUE are closely related to the hardware characteristics and would be set-up in the beginning.

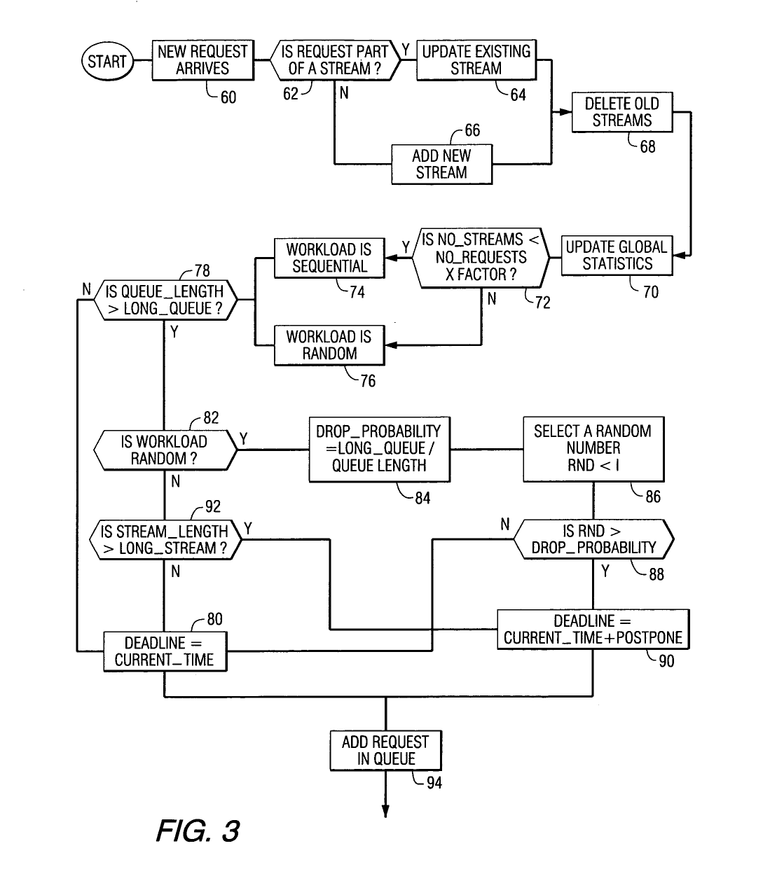

FIG. 3 is a flow diagram that illustrates the admission control algorithm of this invention. New requests are received as shown in block 60. The stream-detect algorithm is used to determine if the new request is part of a stream as shown in block 62. If the new request is part of an existing stream, then the existing stream is updated as shown in block 64. If the new request is not part of an existing stream, then a new stream is added as shown in block 66. Old streams are deleted as shown in block 68, and global statistics are updated as shown in block 70. Next, a determination is made as to whether the number of streams is less than some predetermined portion of the number of requests as shown in block 72.

If the number of streams is less than the predetermined fraction of the number of requests, then the workload is deemed to be sequential as shown in block 74. If the number of streams is greater than the predetermined fraction of the number of requests, then the workload is deemed to be random as shown in block 76. For the purposes of this invention the FACTION parameter having values between 0.5 and 0.75 would be practical. Such values allow for the workload to have several streams that can be postponed in case of an overload.

Next the queue length is compared to a LONG_QUEUE parameter as shown in block 78. If the queue length is less than the LONG_QUEUE parameter, then the deadline for the request is set to be the current time as shown in block 80. If the queue length is greater than the LONG_QUEUE parameter, then if the workload is random (as shown in block 82), the drop probability is equal to the ratio of the LONG_QUEUE to the queue length as shown in block 84 and a random number is selected as shown in block 86. If the random number is greater than the drop probability (as shown in block 88) then the request deadline is set to current time plus POSTPONE as shown in block 90, otherwise, the request deadline is set to the current time.

If the workload is not random, the stream length is compared to the LONG_STREAM parameter as shown in block 92. If the stream length is greater than the LONG_STREAM parameter, the request deadline is set to current time plus the INTERVAL. If the stream length is less than the LONG_STREAM parameter, the request deadline is set to current time. After the request deadlines are set, the request is added to the queue as shown in block 94.

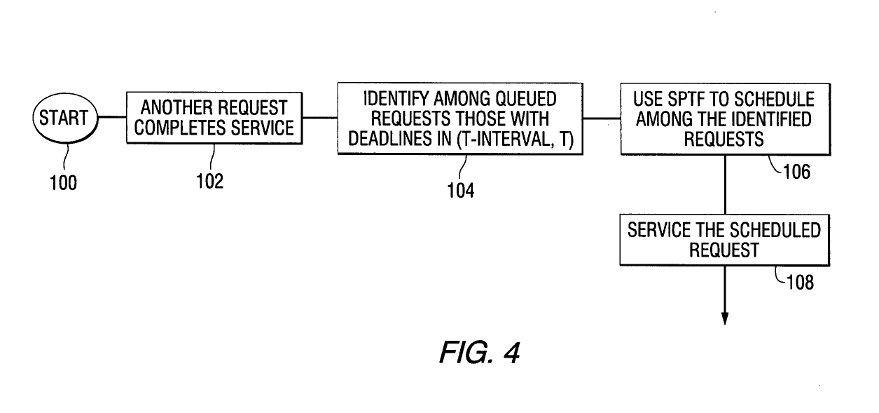

FIG. 4 is a flow diagram that illustrates the admission control method of this invention. The algorithm starts at block 100. After a request has completed its service, as shown in block 102, the requests in the queue that have current deadlines in the interval between T-INTERVAL and T are identified as shown in block 104 (where T is the current time). One of the identified requests is scheduled using the SPTF scheduling algorithm as shown in block 106 and the scheduled request is then serviced as shown in block 108. After the identified request completes its service, the process is repeated. There should be multiple requests between T-INTERVAL and T. The SPTF scheduling algorithm picks the most optimal one of these requests.

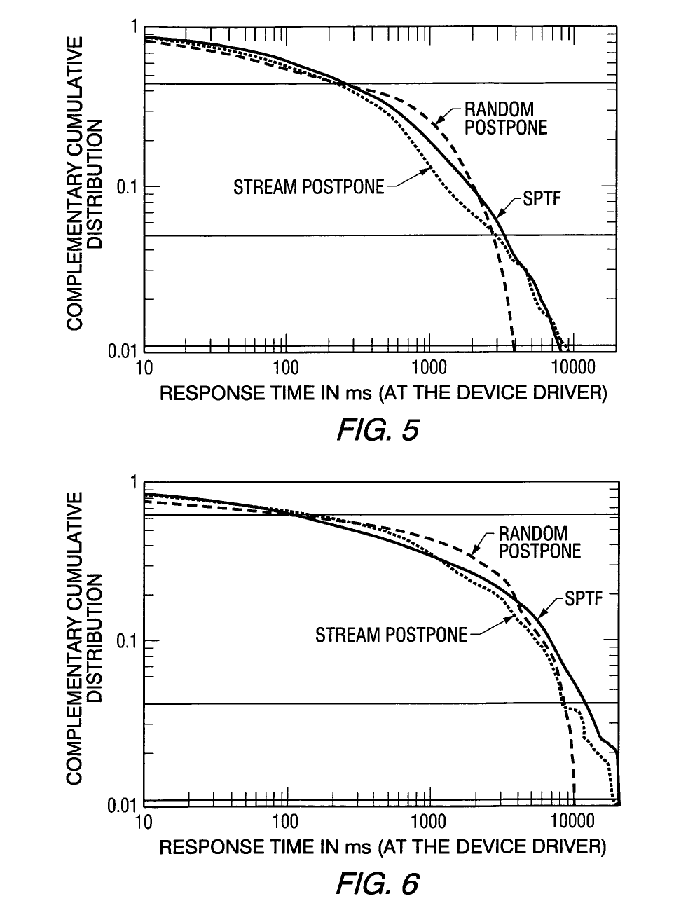

The admission control method has been trace-driven simulated for both the random-postpone and stream-postpone scenarios to analyze the performance of the algorithms. The traces were collected in an E-commerce system running in a laboratory. The access pattern is characterized as random+local+sequential and the arrival intensity is characterized by a sudden increase in the middle of the measured interval. FIGS. 5 and 6 show the response time distribution (complementary cumulative distribution) at the disc driver (host) for the two traces under the stream-postpone scenario, the random-postpone scenario, and the no-admission-control (just SPTF) scenario.

The benefit of postponing streams rather than individual requests is shown in Table 1, where we account for user-level requests that are affected by the admission control algorithm at the disc. Table 1 shows user-level statistics for admission control algorithms wherein either stream requests or random requests are postponed.

TABLE 1

| | | | | | | Post. Reqs |
|---|---|---|---|---|---|---|
| | Algorithm | Streams | Post. | Ratio | 95% RT | in 95% |
| Trace A | Stream-Post. | 15634 | 753 | 0.048 | 3689 | 3689 |
| | Random-Post. | 15634 | 4696 | 0.300 | 3728 | 3728 |
| Trace B | Stream-Post. | 12933 | 357 | 0.028 | 2315 | 2476 |
| | Random-Post. | 12933 | 5032 | 0.389 | 2474 | 2474 |

Table 1 illustrates the performance of both the random-postpone and stream-postpone scenarios measured by the number of user-level requests that are affected by the admission control. In Table 1, the last two columns represent the number of requests that fall within the 95th percentile of the request response times and the number of those requests that were postponed, respectively. Since the ratio between these two metrics is one in most of the cases, the invention targets specific requests to spend more time in the system, thereby managing the tail of the request response time distribution and pushing longer user-level requests (that is, sequential streams) toward the tail of the request response time distribution to achieve better user-level perceived performance.

The number of user-level postponed requests for the stream-postpone scenario is much smaller than for the random-postpone scenario. If random requests are considered to be isolated streams of length l, then we estimate the number of user-level requests that are affected by the admission control algorithm. While for the stream-postpone scenario, this number is kept under 5% of the total number of user-level requests, for random-postpone scenario this number is between 30% and 40% for the two traces used in this analysis.

While the invention has been described in terms of several examples, it will be apparent to those skilled in the art that various changes can be made to the described examples without departing from the scope of the invention as set forth in the following claims.

What is claimed is:

1. A method for processing requests in a data storage system, the method comprising:
receiving a plurality of requests, each of the requests including a block address; and
determining if successive ones of the requests are sequential stream requests by using arrival times of the successive requests and the block addresses of the successive requests.

2. The method of claim 1, wherein the step of determining if successive ones of the requests are sequential stream requests comprises:
comparing a time interval between arrival times of the successive requests to a maximum time parameter;
comparing a block interval between the block addresses of the successive requests to a block distance parameter; and
identifying a most recent one of the successive requests as a stream request if the time interval is less than the maximum time parameter and the block interval is less than the block distance parameter.

3. The method of claim 1, further comprising:
determining if a workload is random or sequential; and
postponing deadlines for individual requests on a random basis if the workload is random; or
postponing deadlines for stream requests if the workload is sequential.

4. The method of claim 1, wherein the step of determining if a workload is random or sequential comprises determining if a number of stream requests in a queue is greater than a predetermined fraction of a total number of requests in the queue.

5. The method of claim 1, further comprising:
determining if a workload is local by comparing a block interval between a largest block and a smallest block in a plurality of the requests with a fraction of available space on a storage medium.

6. The method of claim 1, further comprising:
assigning the requests to a queue;
comparing a number of requests in the queue with a predetermined number; and
if the number of requests in the queue is less than the predetermined number, setting a deadline for the requests as a current time, or if the number of requests in the queue is greater than the predetermined number, postponing deadlines for at least some of the requests.

7. A method for processing requests in a data storage system, the method comprising:
receiving a plurality of requests;
assigning the requests to a queue; and
if the number of requests in the queue exceeds a threshold number, then postponing service for selected ones of the requests, wherein the selection of postponed requests is based on whether a workload is random or sequential.

8. The method of claim 7, further comprising:
determining if the successive requests are stream requests by using arrival times of successive ones of the requests and the block addresses of the successive requests; and
determining that the workload is sequential if a number of stream requests in the queue is greater than a predetermined fraction of total requests in the queue.

9. The method of claim 8, wherein each of the requests includes a block address, and the step of determining if the successive requests are stream requests comprises:
comparing a time interval between the arrival times of successive ones of the requests with a maximum time parameter;
comparing a block interval between the block addresses of the successive requests with a block distance parameter; and
identifying a most recent one of the successive requests as a stream request if the time interval is less than the maximum time parameter and the block interval is less than the block distance parameter.

10. The method of claim 7, further comprising:
determining if a workload is random or sequential; and
postponing deadlines for individual requests on a random basis if the workload is random; or
postponing deadlines for stream requests if the workload is sequential.

11. The method of claim 10, wherein the step of determining if a workload is random or sequential comprises determining if a number of stream requests in the queue is greater than a predetermined fraction of a total number of requests in the queue.

12. An apparatus comprising:
a controller for receiving a plurality of requests, each of the requests including a block address, wherein the controller includes a processor for determining if the successive requests are stream requests by using arrival times of successive ones of the requests and the block addresses of the successive requests.

13. The apparatus of claim 12, wherein the processor compares a time interval between the arrival times of successive ones of the requests with a maximum time parameter; and compares a block interval between the block addresses of the successive requests with a block distance parameter.

14. The apparatus of claim 13, wherein the processor appends a most recent one of the successive requests to a list of stream requests if the time interval is less than the maximum time parameter and the block interval is less than the block distance parameter.

15. The apparatus of claim 12, wherein the processor postpones fulfillment of the stream requests during overload periods.

16. An apparatus comprising:
a controller for receiving a plurality of requests and for assigning the requests to a queue, wherein if the number of requests in the queue exceeds a threshold number, then the controller postpones service for selected ones of the requests, wherein the selection of postponed requests is based on whether a workload is random or sequential.

17. The apparatus of claim 16, wherein the controller determines if the successive requests are stream requests by using arrival times of successive ones of the requests and the block addresses of the successive requests, and determines that the workload is sequential if stream requests are in the queue.

18. The apparatus of claim 17, wherein each of the requests includes a block address, and the controller:
compares a time interval between the arrival times of successive ones of the requests with a maximum time parameter;
compares a block interval between the block addresses of the successive requests with a block distance parameter; and
identifies a most recent one of the successive requests as a stream request if the time interval is less than the maximum time parameter and the block interval is less than the block distance parameter.

19. The apparatus of claim 17, wherein the controller determines if a workload is random or sequential, and postpones deadlines for individual requests on a random basis if the workload is random, or postpones deadlines for stream requests if the workload is sequential.

20. The apparatus of claim 17, wherein the controller determines if a workload is random or sequential by determining if a number of stream requests in the queue is greater than a predetermined fraction of a total number of requests in the queue.
